(19) United States
(12) Patent Application Publication
(10) Pub. No.: US 2022/0414265 A1
(43) Pub. Date: Dec. 29, 2022

(54) System and Method for Generating Search Results Based on Access to User-Approved Information

(71) Applicant: Simon John Roberts, West Palm Beach, FL (US)

(72) Inventor: Simon John Roberts, West Palm Beach, FL (US)

(21) Appl. No.: 17/809,548

(22) Filed: Jun. 28, 2022

Related U.S. Application Data
(60) Provisional application No. 63/215,902, filed on Jun. 28, 2021.

(51) Int. Cl. G06F 21/62; G06Q 30/06; G06F 3/04817; G06F 3/0482; G06F 3/0484

(52) U.S. Cl. CPC G06F 21/6263; G06Q 30/0631; G06Q 30/0643; G06F 3/04817; G06F 3/0482; G06F 3/0484

(57) ABSTRACT

A system and a method for generating search results based on access to user-approved information enable users to get personalized relevant consumable offers by sharing user-approved user information. The user account is prompted to enter a search query. If the search query is entered, the search query is relayed to the remote server. If the public user information meets the minimum information-sharing requirement of the compatible account, an account from the vendor accounts is designated as compatible account. The search query is compared to each consumable-related entry of the compatible account to identify a matching entry from the consumable-related entries of the compatible account. An offer result from the matching entry of the compatible account is generated. The user account is prompted to view the offer result. A viewing payment is executed between the user account and the compatible account, if the offer result is viewed by the user account.

The current application claims a priority to the U.S. provisional patent application Ser. No. 63/215,902 filed on Jun. 28, 2021.

### FIELD OF THE INVENTION

The present invention relates generally to personal data sharing and search methodologies. More specifically, the present invention includes a system and a method that allows users to control the public data that is shared online to generate better search recommendations.

### BACKGROUND OF THE INVENTION

Today, most marketplaces lack the perfect information and the ability to share data which create large inefficiencies that have not allowed the search marketplace to thrive. Perfect information in a marketplace refers to all consumers and providers having perfect and instantaneous knowledge of all market prices, the utility, and cost functions. Further, in decision theory, the expected value of perfect information (EVPI) is equal to the difference between the expected monetary value (EMV), the average return given based on current or available information, and the expected value under certainty, the maximum amount that may be paid for additional (perhaps, perfect) information. Nowadays, advertisers know little about consumers online. The vendors and advertisers (vendors) are largely and increasingly anonymous, especially as ad-blockers and global regulation take force to protect consumer privacy. The vendors knowing little or nothing about the consumer have instead to go to intermediary middlemen who purport to know something about these anonymous consumers.

If the consumers were willing to consent and provide access to key information that may help a vendor to know if they are reaching out to the right person, the consumers may save a considerable amount of wasted money. In addition, users can reduce the friction with vendors by preventing vendors from promoting products or services that were of no interest to the users and more importantly to ensure the advertising message was highly focused to the individual user. The existing search methodologies allow the users to seek products and services by exerting large amounts of time and resources to finding products through search engines and other third-party services. This has put a considerable burden on the consumer. Therefore, there is a need for improved means of facilitating the generation of product and services recommendations to consumers based on personal information that the consumer is willing to share with vendors and advertisers.

An objective of the present invention is to provide a system and a method for generating search results based on access to user-approved information that enables users to search specific products or services by providing specific user data related to several personal attributes. The present invention enables users to select which user data can be shared during a search for a product or service. Another objective of the present invention is to provide a system and a method for generating search results based on access to user-approved information that matches the user's search request with vendors that desire to obtain the user data. The present invention offers the user's search request with no personal identifiable information (PII) to the vendors in exchange for a payment in order for the vendors to transmit an offer regarding the user's search request which the user can view at their leisure in a noninvasive way. This enables vendors to make highly targeted and potentially one-off pricing offers to individuals not able to be seen by anyone else. In addition, this enables users to be compensated for sharing specific user data with the vendors. Another objective of the present invention is to provide a system and a method for generating search results based on access to user-approved information that prevents gamification of the user compensation. The present invention prevents users from making fake searches to receive compensation by implementing a credit system that keeps track of the user's activity. The credit system promotes the interaction between the user and the vendors and punishes the inactivity of the user that may cost the vendor money and time. Additional features and benefits of the present invention are further discussed in the sections below.

### SUMMARY OF THE INVENTION

The present invention provides a system and a method for generating search results based on access to user-approved information. The present invention facilitates the generation of signals which include a search query and user data that the user has agreed to share. This signal-based and consent-based search methodology may operate alongside existing pull search systems to generate search results that are more relevant to the user. By consenting to share select user data, users can be compensated by vendors and advertisers (vendors) who are willing to pay for the user data so they can deliver hyper personalized advertising. As the level of personalized data and behavioral data increases, the user sees their aggregated data valuation rise. Further, more vendors directly integrate their product and service databases into the system of the present invention which allows the present invention to move towards a level of perfect information to match products and services with users. This means that more users can be better matched with products and services compared to traditional push search methods.

Furthermore, the present invention prevents gamification of the user compensation by including a digital credit system that monitors users' behavior to determine the propensity of the user to buy goods that have been signaled. The digital credit system aims to achieve equilibrium in the price advertisers are willing to pay users, meaning that different vendors pay different prices for the same advertising. This digital credit system is central to vendors to protect from users who signal products but do not plan to purchase. In addition, the present invention includes a feedback loop so users can notify vendors if the product or service was purchased. Thus, users protect their credit score by limiting advertising wastage for products and service the users signaled but did not subsequently decide to buy. In other words, users are only compensated if the advertised product or service is purchased. In return, the vendors can be sure which advertising methodologies are the most appropriate for specific users that the vendors desired to target.

### BRIEF DESCRIPTION OF THE DRAWINGS

FIG. 1 is a block diagram for the system of the present invention.

FIG. 2A is a flowchart illustrating the overall process for the method of the present invention.

FIG. 2B is a continuation of the flowchart illustrated in FIG. 2A.

FIG. 3 is a flowchart illustrating the subprocess of inputting public user information.

FIG. 4 is a flowchart illustrating the subprocess of updating public user information.

FIG. 5 is a flowchart illustrating the subprocess of graphically displaying an icon adjacent to a search bar.

FIG. 6 is a flowchart illustrating the subprocess of graphically displaying a plurality of matching entries and a plurality of offer results.

FIG. 7 is a flowchart illustrating the subprocess of graphically removing undesired matching entries.

FIG. 8 is a flowchart illustrating the subprocess of graphically removing undesired offer results.

FIG. 9 is a flowchart illustrating the subprocess of hashing and anonymizing user search information.

FIG. 10 is a flowchart illustrating the subprocess of executing a purchasing payment if an offer result is accepted.

FIG. 11 is a flowchart illustrating the subprocess of monitoring the user engagement by accepting offer results to update a credit rating.

FIG. 12 is a flowchart illustrating the subprocess of submitting a feedback report to maintain the credit rating.

FIG. 13 is a flowchart illustrating the subprocess of monitoring the user engagement by viewing offer results to update the credit rating.

FIG. 14 is a flowchart illustrating the subprocess of monitoring the user engagement by maintain updated public user information to update the credit rating.

### DETAIL DESCRIPTIONS OF THE INVENTION

All illustrations of the drawings are for the purpose of describing selected versions of the present invention and are not intended to limit the scope of the present invention.

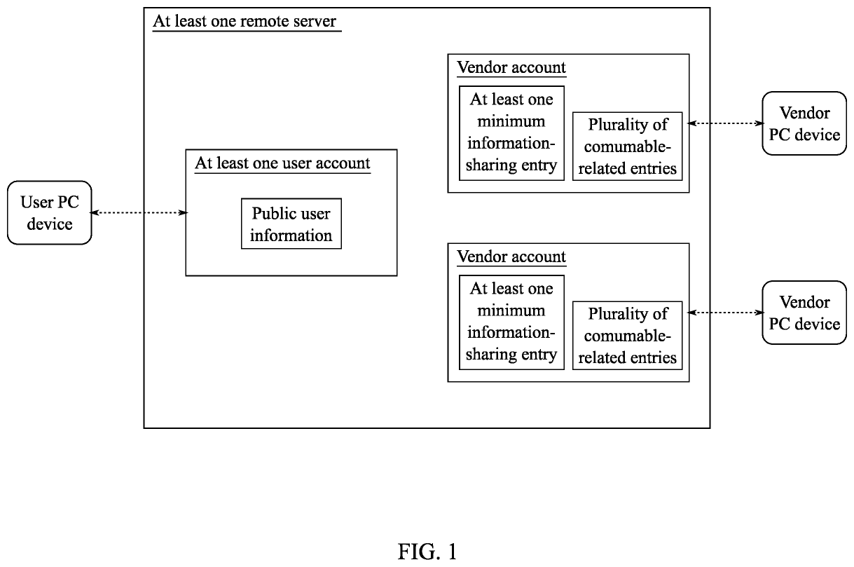

The present invention is a system and a method for generating search results based on access to user-approved information. The present invention enables users to find products and services more relevant to the user's needs by providing select user data that has been approved to be shared by the user to vendors and advertisers (vendors). As can be seen in FIG. 1, to do so, the system of the present invention includes at least one remote server that manages at least one user account (Step A). The user account is associated with a corresponding user personal computing (PC) device, which can be, but is not limited to, a mobile cellular device, a tablet computer, a desktop computer, etc. The user account also includes public user information, which can include, but is not limited to, personal user information that the user has consented to make public and can be shared with specific vendors that match the user's search. In addition, the remote server also manages a plurality of vendor accounts (Step B). The vendor account can correspond to a vendor or advertiser that chooses to participate in the marketplace enabled by the present invention. Each vendor account is associated with a corresponding vendor PC device, which can include, but is not limited to, a mobile cellular device, a tablet computer, a desktop computer, etc. Further, each vendor account includes at least one minimum information-sharing requirement and a plurality of consumable-related entries. The minimum information-sharing requirement includes information about the user data that the vendor desires to obtain from the user. The consumable-related entries include information regarding the products or services offered by the vendor. Both the minimum information-sharing requirement and the consumable-related entries help the present invention match the user's search with the most appropriate vendor. This way, the user is able to receive offers or search results that meet the user's needs and enables the vendors to provide offers or search results that can better target the user.

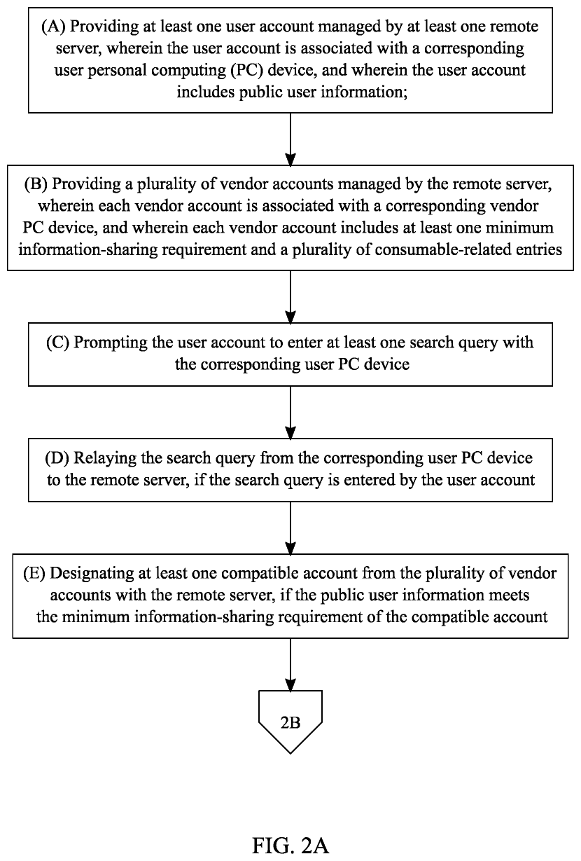

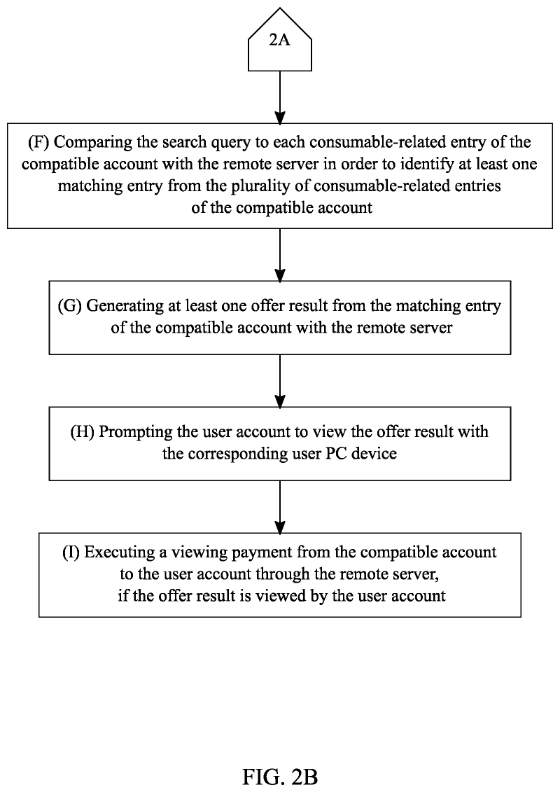

The method of the present invention is designed to enable the user to select the user information to be shared and be compensated for sharing said information with compatible vendors who are interested in that information. As can be seen in FIGS. 2A and 2B, the overall process of the method of the present invention starts by prompting the user account to enter at least one search query with the corresponding user PC device (Step C). For example, the user can be searching for consumables such as clothing, jewelry, or even flight tickets for vacation. If the search query is entered by the user account, the search query is relayed from the corresponding user PC device to the remote server (Step D). The search query is relayed to the remote server so that the remote server can match the user's search query with the most appropriate vendors. At least one compatible account is designated from the plurality of vendor accounts with the remote server, if the public user information meets the minimum information-sharing requirement of the compatible account (Step E). In other words, the remote server matches the public user information with the that desire a certain kind of user information. Then, the search query is compared to each consumable-related entry of the compatible account with the remote server in order to identify at least one matching entry from the plurality of consumable-related entries of the compatible account (Step F). In other words, the remote server ensures that the matched vendors can provide the goods or services that the user is looking for. Then, at least one offer result from the matching entry of the compatible account is generated with the remote server (Step G). The offer result can be provided in the form of an offer from the compatible vendor to the user, such as a discount to the goods or services, or a direct search result that matches the user's search query. Then, the user account is prompted to view the offer result with the corresponding user PC device (Step H). The user is not forced to accept the offer. Instead, the user can consider the offer at the user's discretion before choosing to accept or decline the offer. Finally, a viewing payment is executed between the user account and the compatible account through the remote server, if the offer result is viewed by the user account (Step I). In other words, the user is compensated only if the user chooses to interact with the offer provided by the vendor.

Because the vendor must be willing to pay the user directly to offer a consumable, an environment is created where the vendor provides the best offer with known information towards perfect information. For instance, in the case of searching for a holiday vacation, the user knows valuable information that the vendors may like to know. For example, the user knows the family group size, the approximate budget, preferred date of departure, and the destination that the user might be interested in. The vendors without any of this information may provide poorly targeted advertising that is very expensive for the vendors and frustrating to the user. However, by making a small payment to receive consented public user information from the user, the vendors are able to present a more targeted and specific offer to that user that would more likely create an economic output such as a sale. With reduced wastage, vendors can make better economic pricing opportunities to the user.

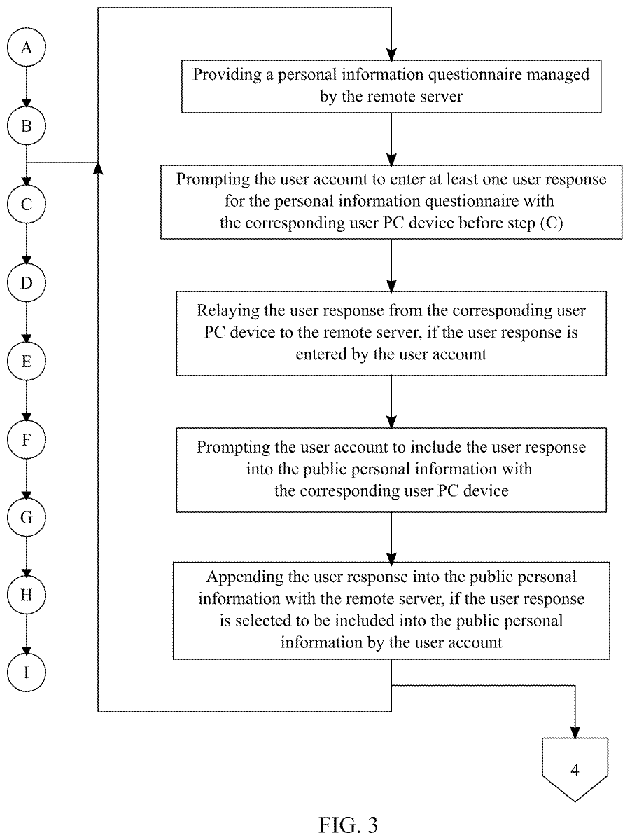

As previously discussed, the present invention implements a consent-based system where users can choose which user information can be shared to the vendors. As can be seen in FIG. 3, to do so, the remote server also manages a personal information questionnaire. The personal information questionnaire encourages the user to share personal information that is of interest to the vendors while also enabling the user to select which personal information can be shared. The subprocess of providing the public user information starts by prompting the user account to enter at least one user response for the personal information questionnaire with the corresponding user PC device before the Step C. The user can choose what personal information to submit using the personal information questionnaire while being encouraged to share as much information as possible. The user response from the corresponding user PC device is relayed to the remote server, if the user response is entered by the user account. In other words, only the personal information provided by the user is stored by the remote server. Then, the user account is prompted to include the user response into the public personal information with the corresponding user PC device. While the user may provide several pieces of personal information, only the personal information that the user consents to make public is shared by the remote server. Then, the user response is appended into the public personal information with the remote server, if the user response is selected to be included into the public personal information by the user account. This way, when the user has interacted with an offer result from the compatible vendor, the remote server provides the compatible vendor with all the user information the user has consented to make public.

The consented public user information may include, but is not limited to, key demographics, geolocation, or intent signals along with bank transaction data, health, energy, and other datasets that the user elects and consents to share. As the user navigates on different devices, information held about the user together with other browsing information, such as competitor sites visited, can be shared to the vendor anonymously. Vendors pay to access the anonymous dataset and provide personalized communications in real-time as well as marketing messages that are sent to the user.

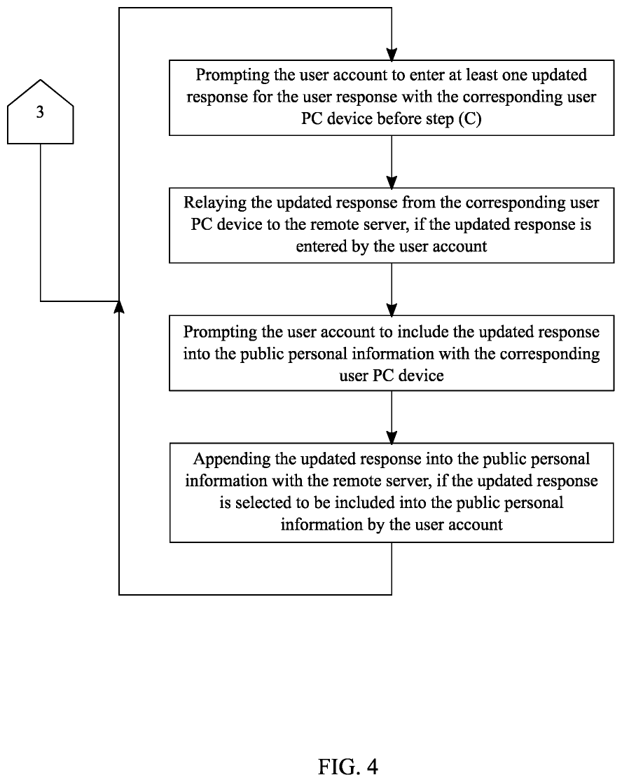

Furthermore, to incentivize the involvement of vendors in the marketplace enabled by the present invention, the present invention encourages the user to maintain the public user information up to date. As can be seen in FIG. 4, the subprocess of maintaining updated public user information starts by prompting the user account to enter at least one updated response for the user response with the corresponding user PC device before the Step C. This way, the public user information can be updated before being shared with compatible vendors, if the user decides to interact with the compatible vendors. Then, the updated response is relayed from the corresponding user PC device to the remote server, if the updated response is entered by the user account. This enables the secure storage of the updated user information in the remote server. Then, the user account is prompted to include the updated response into the public personal information with the corresponding user PC device. In other words, the user can choose to make public the updated user information or not. Finally, the updated response is appended into the public personal information with the remote server, if the updated response is selected to be included into the public personal information by the user account. Thus, the compatible vendor can receive the most up to date user information if the user chooses to interact with the compatible vendor.

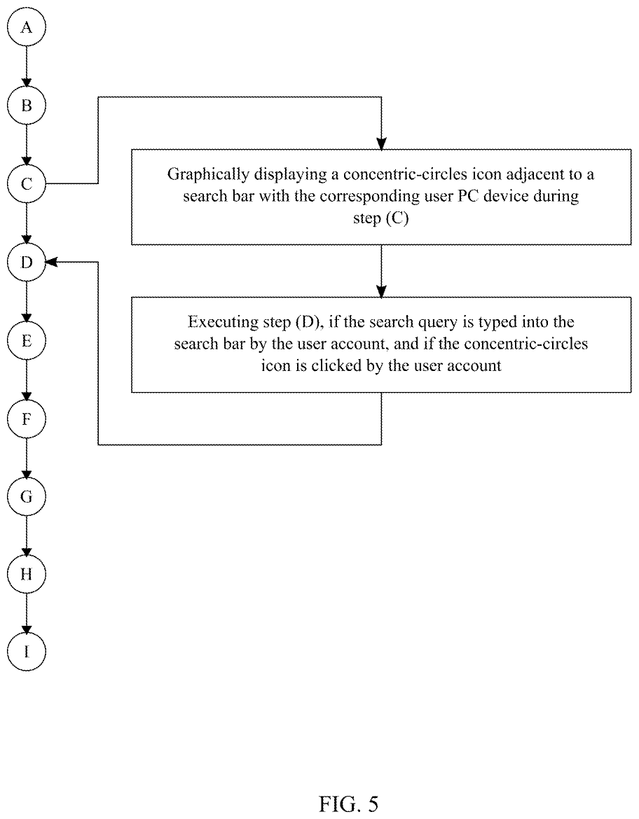

As previously discussed, the present invention can be implemented as an independent system that implements a new online marketplace. Alternatively, the present invention can be implemented to operate with existing third-party services such as existing search engines. As can be seen in FIG. 5, the subprocess of implementing the present invention into existing third-party services includes the steps of graphically displaying a concentric-circles icon adjacent to a search bar with the corresponding user PC device during the Step C. In other words, the present invention can be added to existing search engines as a widget or extension depending on the software application being used by the user. Then, Step D is executed, if the search query is typed into the search bar by the user account, and if the concentric-circles icon is clicked by the user account. By clicking on the concentric-circles icon of the present invention, the search query from the user is performed by the present invention instead of the third-party service. Thus, the user has the ability to choose which service to use when performing a search for goods or services utilizing the desired software application.

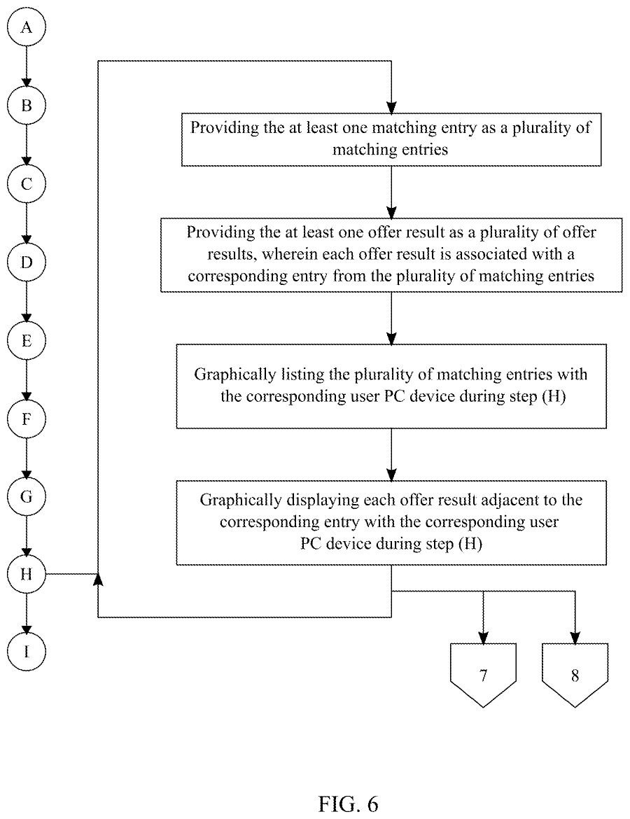

To further facilitate the search of consumables by the user, the present invention provides means to save the searches until the present invention can provide a search result that matches the user's needs. As can be seen in FIG. 6, to do so, the at least one matching entry is provided as a plurality of matching entries. The plurality of matching entries can correspond to different search queries entered by the user. This enables the user to maintain multiple searches active until the user finds the desired result or until the user chooses to terminate the search. In addition, the at least one offer result is provided as a plurality of offer results. Each offer result is associated with a corresponding entry from the plurality of matching entries, which enables the user to receive a specific offer result for each search query that is still active. The subprocess of maintaining multiple search queries active involves the steps of graphically listing the plurality of matching entries with the corresponding user PC device during the Step H. This way, the user can monitor the activity of each search query. In addition, each offer result is graphically displayed adjacent to the corresponding entry with the corresponding user PC device during the Step H. In other words, the user is graphically notified when a new offer result is available to the user. When a new offer result is available to the user, the present invention encourages the user to interact with the offer result as only when the user interacts with the offer result the user is compensated, and the vendor only then receives the public user information.

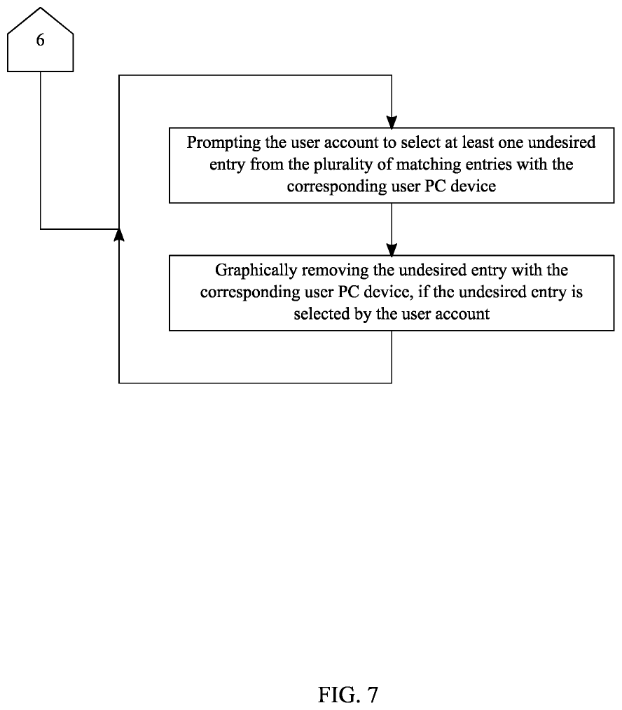

However, the user can choose to not view the offer result or even remove entries if desired. The user can remove the entries for various reasons, such as finding the good or service somewhere else or the user not needing the consumable anymore. As can be seen in FIG. 7, the subprocess of removing undesired entries involves the steps of prompting the user account to select at least one undesired entry from the plurality of matching entries with the corresponding user PC device. This way, the user can choose one or multiple entries at once to remove. Then, the undesired entry is graphically removed with the corresponding user PC device, if the undesired entry is selected by the user account. Thus, the user can monitor active searches that the user still wants to find and remove unwanted searches.

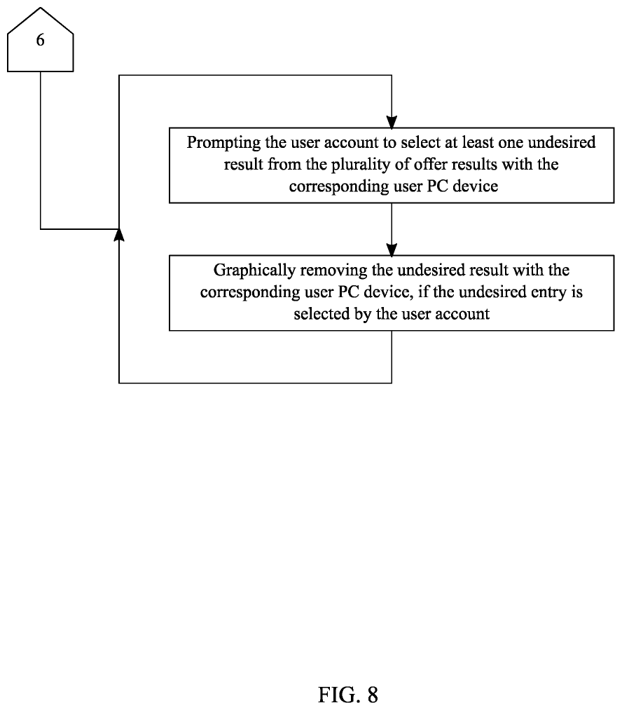

Similar to how the user can remove unwanted searches, the user is also able to remove undesired offers from compatible vendors. As can be seen in FIG. 8, the subprocess of removing undesired offers involves the steps of prompting the user account to select at least one undesired result from the plurality of offer results with the corresponding user PC device. This way, the user can choose one or multiple offers at once to remove. Then, the undesired result is graphically removed with the corresponding user PC device, if the undesired result is selected by the user account. Thus, the user can remove unwanted offers if the user is not interested in the offers.

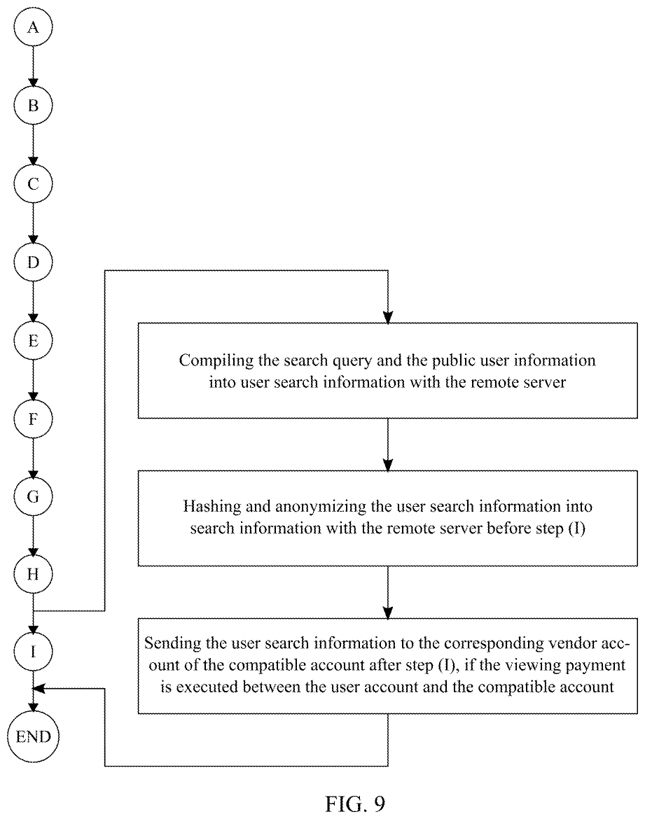

As previously discussed, the consent-based system of the present invention encourages users to share user information with vendors in order to be compensated for doing so. To further encourage the user to share more personal information, the present invention can remove personal identifiable information (PII) to protect the identity of the user. As can be seen in FIG. 9, the subprocess of removing PII includes the steps of compiling the search query and the public user information into user search information with the remote server. After the search query and the public user information are compiled into a data package, the user search information is hashed and anonymized into search information with the remote server before the Step I. By hashing and anonymizing the search information, all PII is removed, thus protecting the identity of the user. Then, the user search information is sent to the corresponding vendor account of the compatible account after the Step I, if the viewing payment is executed between the user account and the compatible account. This way, the user is encouraged to share more personal information that attracts more vendors to participate in the marketplace without compromising the identity of the user.

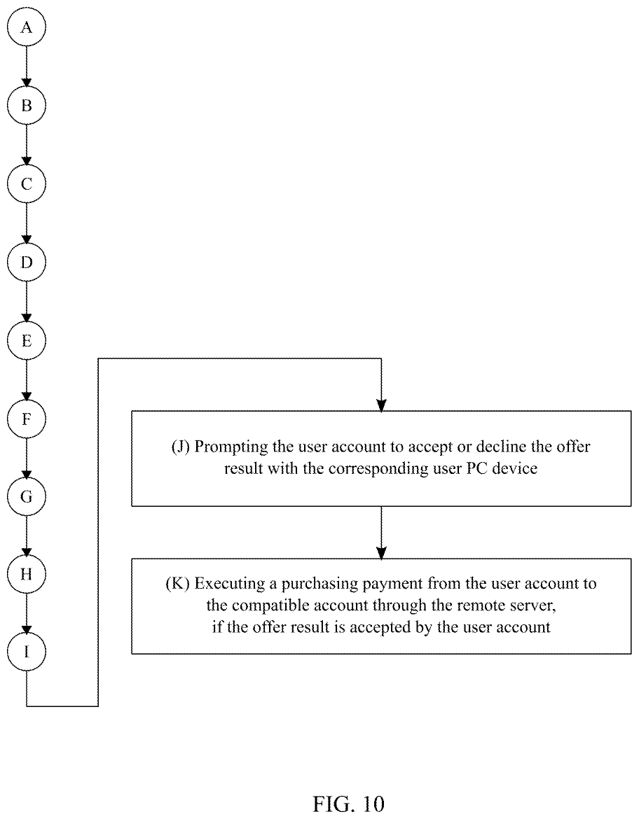

A major goal of the present invention is to promote the transaction of goods and services between the user and the compatible vendors. For example, the compatible vendor is encouraged to provide the best offer to the user so that the user purchases the consumable and so that the vendor receives the public user information. As can be seen in FIG. 10, to do so, the overall process of the present invention may further comprise the steps of prompting the user account to accept or decline the offer result with the corresponding user PC device (Step J). In other words, the user is encouraged to purchase the consumable by accepting the offer provided by the compatible vendor, but the user may choose to not purchase the consumable from the compatible vendor. Further, if the offer result is accepted by the user account, a purchasing payment is executed from the user account to the compatible account through the remote server (Step K). The present invention may provide the financial tools to enable the purchasing payment, or third-party payment services can be utilized to do so.

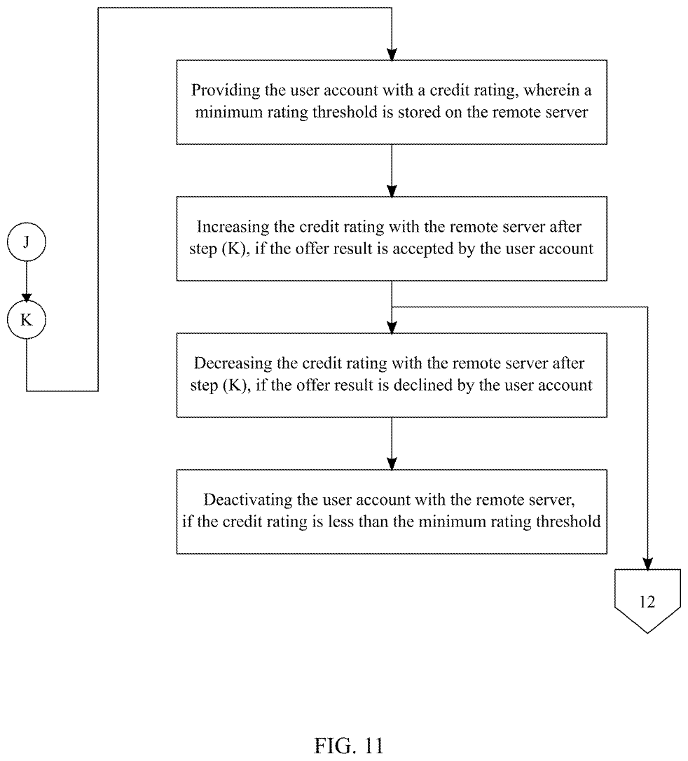

Due to the user compensation features of the present invention, bad actors may be encouraged to game the system of the present invention which can discourage vendors from participating in the marketplace enable by the present invention. As can be seen in FIG. 11, to prevent the gaming of the system of the present invention, the user account is provided with a credit rating. The credit rating is utilized by the credit rating system to monitor the activity of each user account participating in the marketplace enabled by the present invention. Further, a minimum rating threshold is stored on the remote server that enables the credit rating system to determine what actions need to be taken against possible user accounts that negatively impact the system. The subprocess of tracking the engagement of the user account with the offer results involves the steps of increasing the credit rating with the remote server after the Step K, if the offer result is accepted by the user account. By engaging with the offer results provided by the compatible vendors, the credit rating of the user improves, and the compatible vendors are encouraged to provide additional marketing offerings to the user. Alternatively, if the offer result is declined by the user account, the credit rating with the remote server after the Step K. Due to the compatible vendor potentially wasting time and money to provide the offer to the user, the user's credit rating is decreased. If the user fails to engage with several offer results, the user's credit rating can reach the minimum rating threshold. If the credit rating is less than the minimum rating threshold, the user account is deactivated with the remote server. This way, the present invention prevents users from getting compensated without purchasing any consumable in order to try to game the system.

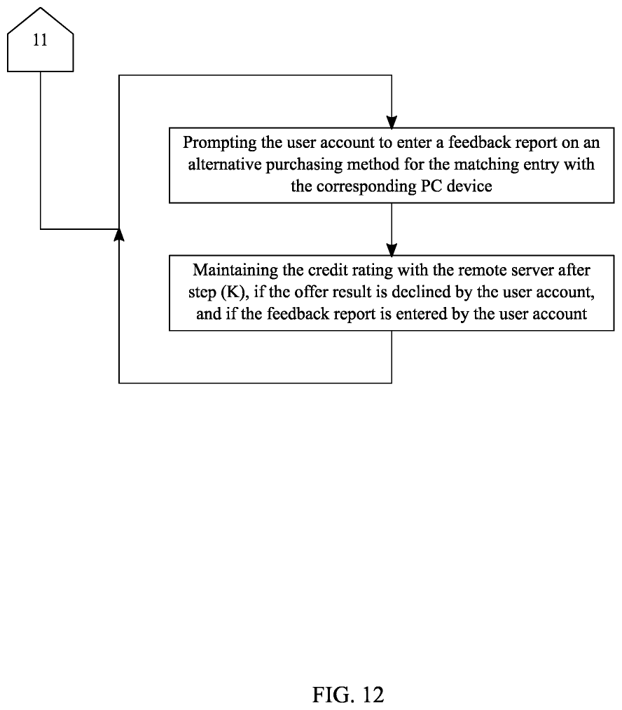

While the user is discouraged from declining several offers provided by compatible vendors, the present invention allows for the user to provide useful feedback to the compatible vendors so that the compatible vendors do not waste time or money providing offer results that do not result in purchases. The feedback can be used by the vendors to generate more efficient offers that are more likely to result in purchases. By providing feedback, the user can prevent the user's credit rating from declining. As can be seen in FIG. 12, the subprocess of providing user feedback involves the step of prompting the user account to enter a feedback report on an alternative purchasing method for the matching entry with the corresponding PC device. The feedback report can provide useful information to the vendors which can include, but is not limited to, reasons as to why the user declined the offer result. For example, the user may not need the consumable anymore, a competitor may provide a better offer, or the offer may not suit the user's needs. Then, if the offer result is declined by the user account, and if the feedback report is entered by the user account, the credit rating is maintained with the remote server after the Step K. This way, the user's credit rating is not affected, and the compatible vendor receives useful feedback for future offers.

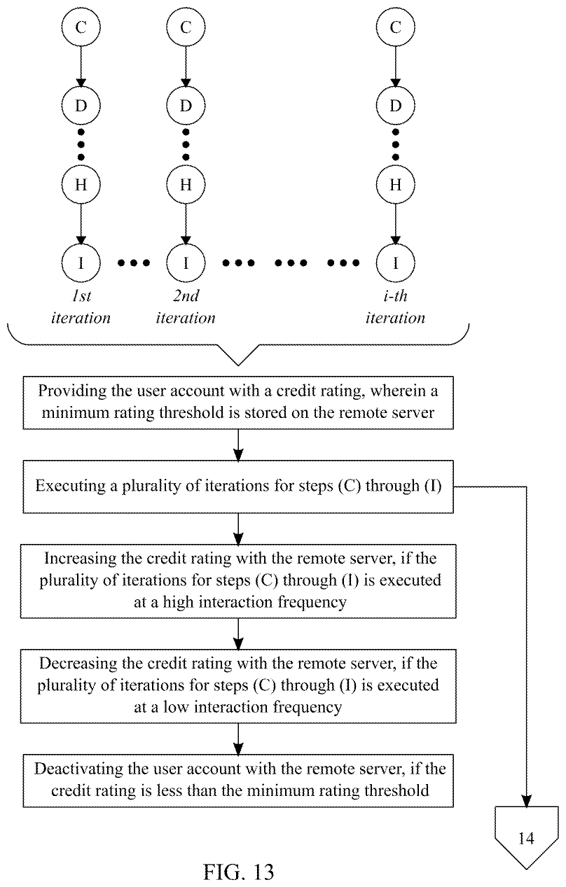

In addition to tracking how often the user accepts the provided offers from the compatible vendors, the credit rating system can also monitor how often the user engages with the offers from the compatible vendors. By increasing the engagement of the users, the present invention encourages vendors to be more participant in the marketplace enabled by the present invention. As can be seen in FIG. 13, the subprocess of monitoring the user engagement involves the steps of executing a plurality of iterations for the Steps C through I. By monitoring the activity of the user across multiple transactions, the credit rating system can better analyze the actions of the user to not mistakenly take action against the user. The credit rating is increased with the remote server, if the plurality of iterations for the Steps C through I is executed at a high frequency. In other words, the more that the user chooses to engage with vendors, the better that the credit rating of the user is as the user is not wasting the vendors marketing efforts. On the other hand, the credit rating is decreased with the remote server, if the plurality of iterations for the Steps C through I is executed at a low frequency. If the user does not engage with the offer results provided by the vendors, the vendors may get discouraged from participating in the marketplace which affects other users. Then, if the credit rating is less than the minimum rating threshold, the user account is deactivated with the remote server. This way, active users are allowed to remain in the marketplace to encourage the participation of more vendors while removing inactive users.

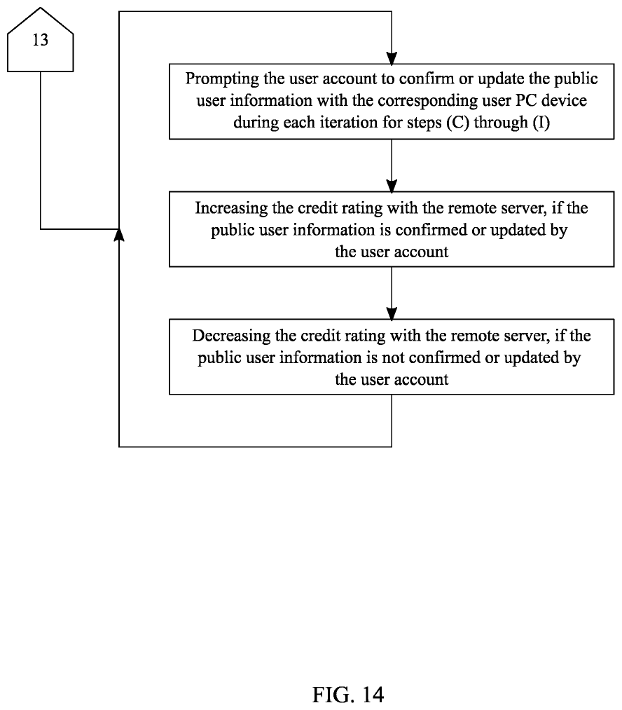

The credit rating of the user is not only affected by the engagement of the user with the offer results provided by the vendors. The credit rating can also be affected by the engagement of the user in providing additional personal user information or maintaining the public user information up to date. As can be seen in FIG. 14, the subprocess of updating the credit rating according to the user's efforts on the public user information involves the steps of prompting the user account to confirm or update the public user information with the corresponding user PC device during each iteration for the Steps C through I. This way, the user is reminded periodically to update the public user information to increase the value of the user's personal information. If the public user information is confirmed or updated by the user account, the credit rating is increase with the remote server. Alternatively, if the public user information is not confirmed or updated by the user account, the credit rating is decreased with the remote server. This way, the user's personal information value is maintained by always providing accurate and up-to-date information to the vendors the user chooses to engage with. In some embodiments, the present invention can include a shopping assistant that allows websites to access the anonymized public user information to generate personalized offers. This leads to a lower bounce rate and greater sales conversion as the user is presented with consumables that better match the user's needs. The user can also be compensated for viewing these personalized offers, purchasing the consumables, or providing feedback on the personalized offers.

Although the invention has been explained in relation to its preferred embodiment, it is to be understood that many other possible modifications and variations can be made without departing from the spirit and scope of the invention.

What is claimed is:

1. A method for generating search results based on access to user-approved information, the method comprising the steps of:
(A) providing at least one user account managed by at least one remote server, wherein the user account is associated with a corresponding user personal computing (PC) device, and wherein the user account includes public user information;
(B) providing a plurality of vendor accounts managed by the remote server, wherein each vendor account is associated with a corresponding vendor PC device, and wherein each vendor account includes at least one minimum information-sharing requirement and a plurality of consumable-related entries;
(C) prompting the user account to enter at least one search query with the corresponding user PC device;
(D) relaying the search query from the corresponding user PC device to the remote server, if the search query is entered by the user account;
(E) designating at least one compatible account from the plurality of vendor accounts with the remote server, if the public user information meets the minimum information-sharing requirement of the compatible account;
(F) comparing the search query to each consumable-related entry of the compatible account with the remote server in order to identify at least one matching entry from the plurality of consumable-related entries of the compatible account;
(G) generating at least one offer result from the matching entry of the compatible account with the remote server;
(H) prompting the user account to view the offer result with the corresponding user PC device; and
(I) executing a viewing payment from the compatible account to the user account through the remote server, if the offer result is viewed by the user account.

2. The method as claimed in claim 1 comprising the steps of:
providing a personal information questionnaire managed by the remote server;
prompting the user account to enter at least one user response for the personal information questionnaire with the corresponding user PC device before step (C);
relaying the user response from the corresponding user PC device to the remote server, if the user response is entered by the user account;
prompting the user account to include the user response into the public personal information with the corresponding user PC device; and
appending the user response into the public personal information with the remote server, if the user response is selected to be included into the public personal information by the user account.

3. The method as claimed in claim 2 comprising the steps of:
prompting the user account to enter at least one updated response for the user response with the corresponding user PC device before step (C);
relaying the updated response from the corresponding user PC device to the remote server, if the updated response is entered by the user account;
prompting the user account to include the updated response into the public personal information with the corresponding user PC device; and
appending the updated response into the public personal information with the remote server, if the updated response is selected to be included into the public personal information by the user account.

4. The method as claimed in claim 1 comprising the steps of:
graphically displaying a concentric-circles icon adjacent to a search bar with the corresponding user PC device during step (C); and
executing step (D), if the search query is typed into the search bar by the user account, and if the concentric-circles icon is clicked by the user account.

5. The method as claimed in claim 1 comprising the steps of:
providing the at least one matching entry as a plurality of matching entries;
providing the at least one offer result as a plurality of offer results, wherein each offer result is associated with a corresponding entry from the plurality of matching entries;
graphically listing the plurality of matching entries with the corresponding user PC device during step (H); and
graphically displaying each offer result adjacent to the corresponding entry with the corresponding user PC device during step (H).

6. The method as claimed in claim 5 comprising the steps of:
prompting the user account to select at least one undesired entry from the plurality of matching entries with the corresponding user PC device; and
graphically removing the undesired entry with the corresponding user PC device, if the undesired entry is selected by the user account.

7. The method as claimed in claim 5 comprising the steps of:
prompting the user account to select at least one undesired result from the plurality of offer results with the corresponding user PC device; and
graphically removing the undesired result with the corresponding user PC device, if the undesired entry is selected by the user account.

8. The method as claimed in claim 1 comprising the steps of:
compiling the search query and the public user information into user search information with the remote server;
hashing and anonymizing the user search information into search information with the remote server before step (I); and
sending the user search information to the corresponding vendor account of the compatible account after step (I), if the viewing payment is executed between the user account and the compatible account.

9. The method as claimed in claim 1 comprising the steps of:
(J) prompting the user account to accept or decline the offer result with the corresponding user PC device; and
(K) executing a purchasing payment from the user account to the compatible account through the remote server, if the offer result is accepted by the user account.

10. The method as claimed in claim 9 comprising the steps of:
providing the user account with a credit rating, wherein a minimum rating threshold is stored on the remote server;
increasing the credit rating with the remote server after step (K), if the offer result is accepted by the user account;
decreasing the credit rating with the remote server after step (K), if the offer result is declined by the user account; and
deactivating the user account with the remote server, if the credit rating is less than the minimum rating threshold.

11. The method as claimed in claim 10 comprising the steps of:
prompting the user account to enter a feedback report on an alternative purchasing method for the matching entry with the corresponding PC device; and
maintaining the credit rating with the remote server after step (K), if the offer result is declined by the user account, and if the feedback report is entered by the user account.

12. The method as claimed in claim 1 comprising the steps of:
providing the user account with a credit rating, wherein a minimum rating threshold is stored on the remote server;
executing a plurality of iterations for steps (C) through (I);
increasing the credit rating with the remote server, if the plurality of iterations for steps (C) through (I) is executed at a high interaction frequency;
decreasing the credit rating with the remote server, if the plurality of iterations for steps (C) through (I) is executed at a low interaction frequency; and
deactivating the user account with the remote server, if the credit rating is less than the minimum rating threshold.

13. The method as claimed in claim 12 comprising the steps of:
prompting the user account to confirm or update the public user information with the corresponding user PC device during each iteration for steps (C) through (I);
increasing the credit rating with the remote server, if the public user information is confirmed or updated by the user account; and
decreasing the credit rating with the remote server, if the public user information is not confirmed or updated by the user account.
